(19) United States
(12) Patent Application Publication
(10) Pub. No.: US 2026/0222971 A1
(43) Pub. Date: Jul. 30, 2026

(54) SYSTEM AND METHOD OF CONFIGURING A WIRELESS NETWORK TO SELECTIVELY BROADCAST SERVICE SET IDENTIFIERS

(71) Applicant: 5321 Innovation Labs LLC, Franklin, MA (US)

(72) Inventors: Edward W. Neipris, Wrentham, MA (US); Mikenzie Reeder Wade, Castle Rock, CO (US); Tyler Richard Nesper, Denver, CO (US); David R. Doiron, Franklin, MA (US)

(21) Appl. No.: 19/460,813

(22) Filed: Jan. 27, 2026

Related U.S. Application Data
(60) Provisional application No. 63/750,103, filed on Jan. 27, 2025.

(51) Int. Cl. H04W 48/10; H04W 12/06; H04W 48/18; H04W 64/00

(52) U.S. Cl. CPC H04W 48/10; H04W 12/06; H04W 48/18; H04W 64/00

(57) ABSTRACT

A wireless network is configured to selectively broadcast the unique service set identifier (SSID) for each of its plurality of subnetworks. The wireless network maintains a lookup table that links the Media Access Control (MAC) address of each wireless device seeking network connection with the SSIDs of a selection of the subnetworks. Accordingly, when a device sends a connection request, only authenticated SSIDs will be broadcast by network access points (APs) in response. In this manner, connection to a private network is capable of being seamlessly passed among APs as the user roams throughout the network environment. Furthermore, this discreet broadcasting of network SSIDs to only authenticated devices effectively restricts visibility of SSIDs to unauthorized devices within its physical range. Optionally, if no SSIDs are associated with a device in the lookup table, the wireless network may create a dynamic SSID as a default network connection for the device.

### CROSS-REFERENCE TO RELATED APPLICATIONS

The present invention claims the benefit under 35 U.S.C. 119(e) to U.S. Provisional Patent Application No. 63/750,103, which was filed on January 27, 2025, in the names of Edward W. Neipris et al., the disclosure of which is incorporated herein by reference.

### FIELD OF THE INVENTION

The present invention relates generally to the field of wireless networks and, more particularly, to methods for configuring wireless networks to expand the range of network connectivity while maintaining optimal network security.

### BACKGROUND OF THE INVENTION

A ubiquitous wireless network, or ubiquitous network, is an advanced wireless network that supports seamless, reliable, and uninterrupted network connectivity across an expansive physical environment. Ubiquitous wireless networks are prevalent in a wide range of settings that require consistent connectivity as a device travels throughout a defined geographic area, such as, but not limited to, a hotel, an apartment complex, an educational campus, a business office, or even a single-family residence.

Typically, a ubiquitous network includes a plurality of interconnected wireless access points (WAPs), or access points (APs), in communication with various network services (e.g., internet access) and network devices (e.g., network printers). Each access point is responsible for, inter alia, broadcasting the network connectivity options and, in turn, regulating network access to wirelessly enabled devices within its geographic range. To increase network range in larger physical environments, a multitude of access points are typically utilized and physically arranged in an optimized configuration.

In larger settings, a wireless network is often segmented into a plurality of distinct, isolated subnetworks, or subnets, each with its own unique set of network settings and access controls. The creation of these individualized networks serves to, inter alia, (i) improve security (e.g., by differentiating between private and public access), (ii) enhance performance (e.g., by restricting network access to an optimal wireless frequency band), and (iii) facilitate organization and management between different user groups (e.g., staff and students) to better streamline traffic flow.

To help a user differentiate between multiple available networks within close range, each network is ordinarily provided with a unique network name, or service set identifier (SSID). Additionally, each network may require a password or other similar authentication method. Access to each of the individual networks is regulated by one or more of the wireless access points.

It should be noted that each access point is configured to broadcast one or more preconfigured SSIDs to network-enabled devices within its range. A network-enabled device, also referred to herein as a station (STA), represents any device capable of wireless connection with an access point and encompasses, inter alia, smartphones, laptops, smartwatches, printers, and Internet of Things (IoT) devices.

Typically, an access point is configured to broadcast a designated set of SSIDs that are local to the network. In other words, an access point broadcasts the SSIDs within its immediate physical environment (e.g., a room, floor, or building) and without expanding out to a wider, or remote, network. The local broadcasting of the SSID helps to ensure that network access is restricted to authorized users, thereby rendering the network safer and more secure.

A network operator (e.g., a homeowner, network administrator, or service provider) is typically responsible for manually defining which SSIDs are to be broadcast on each access point within the network. Through this configuration process, a limited geographic boundary is established for each SSID that is presented to local STAs for network connection.

For example, an access point located in a hotel room may be solely configured to broadcast the SSID of a private network designated for the occupant of that room. As another example, an access point located in a shared space (e.g., a lobby) may be configured to locally broadcast the SSIDs of multiple networks (e.g., a public guest network, a private resident network, and a private office administration network).

In certain instances, it has been found that the geographical boundary established for a particular SSID is not sufficient to maintain seamless network connectivity and roaming for authenticated STAs. For instance, a resident in an apartment complex may have a private wireless network established within the confines of the apartment (i.e., by a single AP located within that apartment). However, if the resident were to leave the apartment, access to the private network may be lost if other access points within the building are not similarly configured to broadcast the network SSID.

At the same time, it should be noted that expanding the geographical coverage of a designated network by configuring additional access points to broadcast the same network SSID would introduce inherent security risks. For example, in a hotel setting, the SSID of a private network created for a local guest could be broadcast by various access points located throughout the building in order to afford the guest with seamless connectivity. However, as a consequence, the private network would become visible to unauthorized users within its vicinity (e.g., other hotel guests or property visitors). This visibility renders certain settings of the network (e.g., the SSID and password) exposed for interception by unscrupulous individuals. This, in turn, presents serious cybersecurity threats in the form of, among other things, man-in-the-middle (MITM) attacks, radio frequency (RF) sniffing, data interception, and the like.

Various techniques have been utilized to expand the geographical boundaries of individual networks within a large-scale environment without significantly compromising security.

As an example, a network operator may configure a network to broadcast the same network settings across several APs and wireless networks. This technique is often utilized by organizations, such as hotel chains, by broadcasting the same SSID at each property and on each wireless network. As can be appreciated, using a common SSID at various locations may allow for a single enhanced set of security measures to be implemented.

As another example, a user may elect to manually maintain, or store, a list of wireless networks to which connection has been previously established. If the SSID of one of the stored networks is being broadcast within the current geographical location of the user, the user STA will automatically connect. Otherwise, the user would need to scan for available networks, retrieve the appropriate settings from the network operator, and manually connect to the SSID.

As yet another example, a network operator may elect to implement complex security mechanisms to overcome any security risks created by broadcasting an SSID throughout a large-scale environment. These security mechanisms include, but are not limited to, (i) installing certificates on each STA to identify the user and encrypt traffic or (ii) providing the user with individual authentication credentials (e.g., a username and password or individual pre-shared keys).

### SUMMARY OF THE INVENTION

In view thereof, it is an object of the present invention to provide a novel system and method for configuring a wireless network to selectively broadcast the service set identifier (SSID) for one or more of its subnetworks.

It is another object of the present invention to provide a system and method of the type as described above wherein the SSID is selectively broadcast across multiple access points (APs) in order to provide seamless, reliable, and expansive network connectivity.

It is yet another object of the present invention to provide a system and method of the type as described above wherein SSID broadcasting is restricted to authorized devices to optimize security and thereby minimize the risk of cybersecurity threats.

It is still another object of the present invention to provide a system and method of the type as described above which is inexpensive to implement and readily scalable.

Accordingly, as one feature of the present invention, there is provided a wireless network connection system comprising (a) a wireless network configured with a plurality of subnetworks, each subnetwork having a unique service set identifier (SSID), the wireless network comprising, (i) one or more network resources, (ii) a plurality of access points in communication with the one or more network resources, and (iii) a database in communication with each of the plurality of access points, the database maintaining a lookup table, and (b) an electronic device seeking connection with the wireless network, the electronic device having an identifier, (c) wherein the lookup table cross-references the identifier for the electronic device with the SSID of a selection of the plurality of networks, (d) wherein the plurality of access points only broadcasts to the electronic device the SSIDs of subnetworks associated with the identifier for the electronic device in the lookup table.

Various other features and advantages will appear from the description to follow. In the description, reference is made to the accompanying drawings which form a part thereof, and in which is shown by way of illustration, an embodiment for practicing the invention. The embodiment will be described in sufficient detail to enable those skilled in the art to practice the invention, and it is to be understood that other embodiments may be utilized and that structural changes may be made without departing from the scope of the invention. The following detailed description is therefore, not to be taken in a limiting sense, and the scope of the present invention is best defined by the appended claims.

### BRIEF DESCRIPTION OF THE DRAWINGS

In the drawings, wherein like reference numerals represent like parts:

FIG. 1 is a simplified block diagram of a system for connecting to a wireless network, the system being designed according to the teachings of the present invention; and

FIG. 2 is a flow chart depicting a novel process for broadcasting a subnetwork service set identifier (SSID) to a network-enabled wireless device using the system shown in FIG. 1.

### DETAILED DESCRIPTION OF THE INVENTION

### Wireless Network Connection System 11

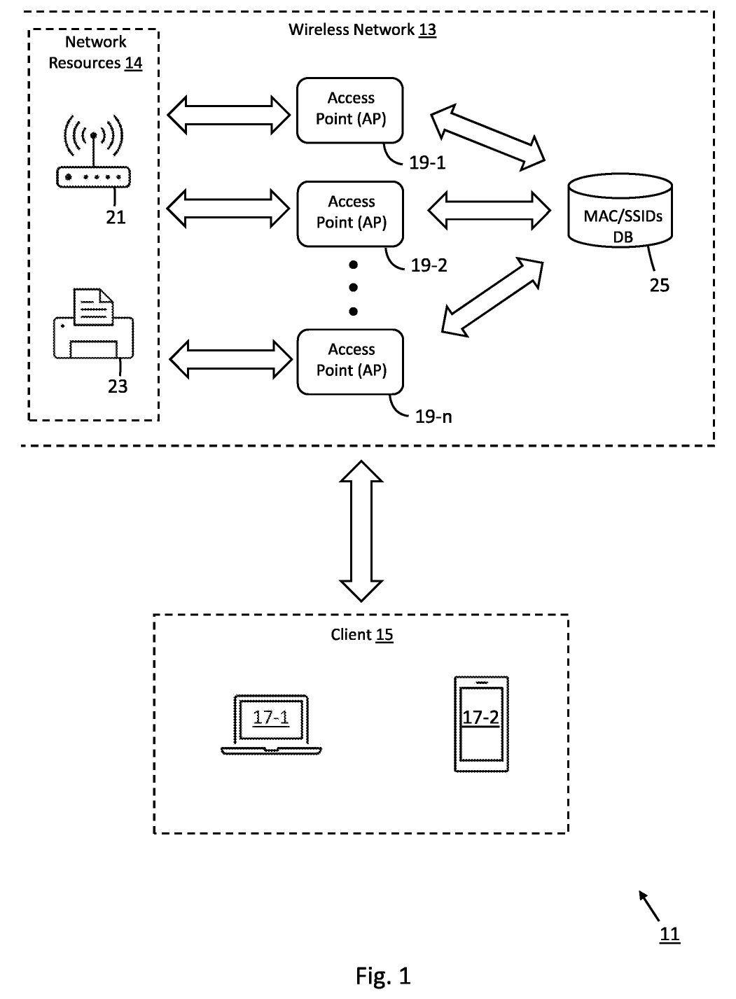

Referring now to FIG. 1, there is shown the basic architecture of a system for connecting to a wireless network, the system being designed according to the teachings of the present invention and identified generally by reference numeral 11. As will be explained in detail below, system 11 is configured with service set identifier (SSID) broadcasting rules that restrict the broadcasting of subnet SSIDs to authenticated wireless devices. Moreover, system 11 is uniquely configured to enable an authenticated wireless device to remain in connection with a private subnetwork by discreetly broadcasting the subnetwork SSID to the wireless device across various access points (APs) as the user roams throughout the network environment. As a result, a client device is afforded with both secure and reliable network connectivity within a relatively expansive geographic area, which is a principal object of the present invention.

As can be seen, system 11 comprises (i) a wireless network 13 that provides selective access to various network resources 14, and (ii) at least one user, or client, 15 seeking access to wireless network 13. Although not shown herein, it is to be understood that wireless network 13 is preferably segmented into a plurality of distinct and isolated subnetworks, or subnets, each with its own unique set of network settings and access controls. To help a user differentiate between multiple available subnetworks within close range, each subnetwork is ordinarily provided with a unique network name, or service set identifier (SSID). Additionally, each subnetwork may require a password or other similar authentication method.

For simplicity and ease of illustration, system 11 is shown depicting a single client 15 seeking connection to wireless network 13. However, it is to be understood that, in actuality, system 11 would typically include a plurality of users 15 seeking connection to wireless network 13 at the same time.

Additionally, in the present embodiment, client 15 is shown comprising a pair of client devices 17-1 and 17-2. Each client device, or station (STA), 17 represents any wirelessly-enabled electronic device. For instance, STA 17-1 is depicted herein as a laptop computer and STA 17-2 is depicted herein as a smartphone. However, it to be understood that the number and/or type of devices 17 could be modified without departing from the spirit of the present invention. For instance, each STA 17 could alternatively be in the form of, inter alia, a smartwatch, a wireless printer, or an Internet of Things (IoT) device.

As can be appreciated, the specific design and means by which wireless network 13 broadcasts subnet SSIDs are considered novel. Most notably, wireless network 13 is uniquely configured to enable an STA 17 to remain in connection with a private subnetwork by discreetly broadcasting the subnetwork SSID to the STA 17 across various access points (APs) as the user roams throughout the physical boundaries of wireless network 13. In other words, connection to a private network is passed among APs based on the physical proximity of STA 17 relative to each AP. So, as STA 17 travels outside the network range of one access point, connection is preferably established through another access point in closer proximity to STA 17. As a result, a client 15 is afforded with secure and reliable network connectivity across a relatively expansive geographic area.

### Wireless Network 13

As referenced above, wireless network 13 is an advanced wireless network that supports seamless, reliable, and uninterrupted network connectivity across an expansive physical environment. As a primary feature of the present invention, wireless network 13 is uniquely configured to enable an authenticated STA 17 to maintain connection to a private subnet of network 13 through a chain, or matrix, of network connection points. As a result, client 15 is able to freely roam throughout the geographic expanse of wireless network 13 without network interruption.

As seen in FIG. 1, wireless network 13 is similar in design to a conventional wireless network in that ubiquitous wireless network 13 comprises (i) a variety of network resources 14, and (ii) a plurality of wireless access points (WAPs), or access points (APs), 19-1 thru 19-n in communication with network resources 14. As can be appreciated, network resources 14 are delivered to authorized users 15 via access points 19.

Network resources 14 is represented herein as comprising (i) a variety of network services, such as internet services provided via router 21, and (ii) a variety of network devices, such as a network printer 23. Together, network resources 14 and access points 19 are responsible for, inter alia, establishing wireless network 13 (including all of its subnetworks), maintaining a service set identifier (SSID) for each network as a means for identification by each client 15 within range, and defining the capabilities of each network SSID (e.g., the connection type, authentication method, and encryption method for the network).

Each access point 19 is a network device that enables authenticated electronic devices 17 to connect to network 13 and, in turn, utilize available network devices and services. In the present embodiment, a plurality of interconnected access points 19 is utilized and configured to broaden the range of network 13 and thereby ensure reliable network connectivity. As needed, additional access points 19 could be readily integrated into network 13 to further expand the scope of network 13 and thereby support even larger network coverage.

Wireless network 13 differs from a conventional network in that wireless network 13 maintains a database 25 in communication with each access point 21. As will be explained further below, database 25 compiles and maintains a lookup table that links an identifier associated with each STA 17 with a selection of authorized network SSIDs to be broadcast by access points 19 to that particular STA 17. In other words, database 25 is utilized to restrict the network SSIDs broadcast by access points 19 to only those devices 17 that are authorized to connect to that particular network, thereby blocking the visibility of the SSID of all private networks to any unauthorized clients 15 within its physical range (i.e., for security purposes).

In the description that follows, the preassigned Media Access Control (MAC) address is primarily utilized as the identifier for each client device 17. However, it should be noted that the present invention is not limited to the use of a MAC address as a means for identifying each STA 17. Rather, it is to be understood that alternative types of identifiers could be used in place thereof without departing from the spirit of the present invention. For example, additional device identifiers may include, inter alia, a set of authentication credentials, a device name, a device type, email address, customer loyalty number, apartment number, patient record identifier, or probe request data, which may include, but is not limited to, an SSID name, STA capabilities, vendor-specific parameters, or a combination of parameters sent via probe request.

### Network Broadcasting Regulation Process 111

As referenced above, system 11 is uniquely designed to implement a novel process for regulating the broadcasting of network SSIDs to individual STAs 17, the process being identified generally herein using reference numeral 111. As will be explained in detail below, process 111 restricts the broadcasting of network SSIDs to only those STAs 17 authorized to connect to that particular network, thereby blocking the visibility of the SSID of all private networks to any unauthorized clients 15 within its physical range.

As an additional feature of the present invention, process 111 may dynamically create a new network SSID if no other private network is determined suitable for broadcasting to the particular STA 17. Furthermore, process 111 may integrate a rules engine to determine the specifics regarding the creation of any dynamic network SSID. For instance, the rules engine may determine certain parameters regarding the dynamic SSID, which may include, but are not limited to, time of day restrictions, allotted bandwidth, virtual local area network (VLAN) limitations, and/or numbers of allowed STAs.

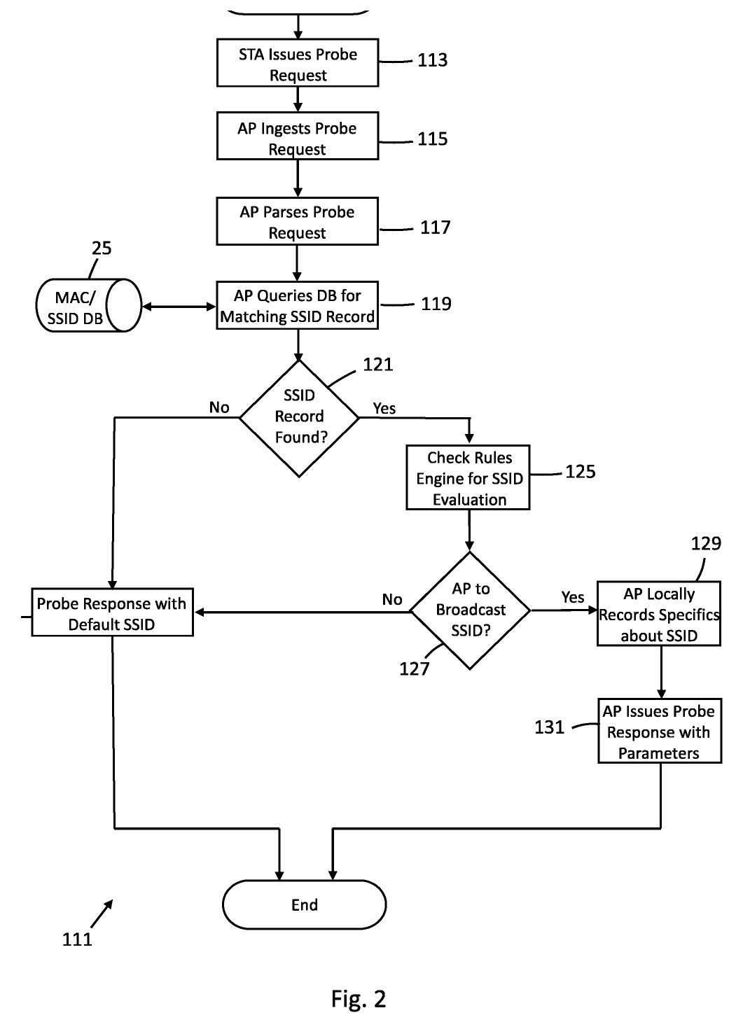

Referring now to FIG. 2, there is shown a simplified flow chart of network broadcasting regulation process, or method, 111. As can be seen, when attempting to connect to wireless network 13, a station 17 first issues a probe, or connection, request, the probe request being represented generally as step 113 in FIG. 2.

The probe request sent by STA 17 is a broadcast message sent to all available APs 19 within listening distance. As part of step 113, STA 17 requests that each AP 19 return values indicating the connectivity options available through the particular AP 19. Additionally, STA 17 requests each access point 19 provide the capabilities of each connection option, such as, but not limited to, SSID name, network connection type, method of user authentication, and the active protocol of wireless encryption.

Upon receiving the probe request, each access point 19 capable of providing network connection ingests the probe request, as shown in step 115. Thereafter, access point 19 parses the parameters of the probe request in order to retrieve pertinent information associated with the STA 17 issuing the probe request, the parsing step being represented generally by reference numeral 117 in FIG. 2. As previously referenced, the pertinent information associated with the STA 17 is preferably in the form of its Media Access Control (MAC) address but may additionally include, inter alia, a specific network SSID, capabilities of the STA 17, vendor-specific parameters, or a combination thereof.

Having received the MAC address from STA 17, access point 19 transmits a query to database 25 to perform a lookup of the MAC address for the STA 17 in the MAC/SSID lookup table maintained by database 25, as represented generally by step 119 in FIG. 2. Lookup step 119 can be performed using various techniques including, but not limited to, a direct database lookup, an Application Programming Interface (API) request, or a Remote Authentication Dial-In User Service (RADIUS) access request.

It should be noted that database 25 may be maintained locally on AP 19. Alternatively, it is to be understood that database 25 may be maintained as an external repository, such as an AP controller, cloud repository, or any other similar type of data repository that is capable of responding to lookup queries.

As part of step 121, access point 19 determines whether the MAC address for the STA 17 is currently associated, or matches, with any network SSIDs. In other words, access point 19 determines which, if any, network SSIDs are authorized to be broadcast to client device 17.

If the STA 17 does not have any authorized network SSIDs associated with its MAC address in MAC/SSID database 25 (e.g., due to no previous attempt to connect to network 13), network 13 may dynamically create a new network SSID for STA 17 and, in turn, maintain the information in the MAC/SSID lookup table for future reference. Thereafter, all access points 19 within range that heard the initial probe request will issue a probe response to STA 17, as represented by response step 123 in FIG. 2. As part of the probe response, all access points 19 will broadcast the dynamic, or default, SSID.

It should be noted that, in lieu of broadcasting the dynamic SSID to STA 17 as part of step 123, network 13 may be alternatively configured to broadcast no information (e.g., network SSIDs). As a result, an STA 17 that is not associated with any known SSIDs in database 25 would be effectively precluded from connecting to wireless network 13 (i.e., for security purposes).

Returning back to determining step 121, if the STA 17 has one or more network SSIDs already associated with its MAC address in MAC/SSID database 25, access point 19 may optionally send the information to a rules engine for SSID evaluation, as represented by evaluation step 125. As part of the SSID evaluation process, the rules engine may use SSID information from the record (e.g., a unique identifier, an SSID name, SSID authentication options, and/or SSID encryption options) to determine whether to instruct the AP 19 on features of the SSID. Features may include, but are not limited to, rewriting SSID parameters based on certain factors (e.g., geographic location) and/or whether to broadcast a verified SSID.

If a rules engine is not utilized, or if the rules engine permits broadcasting of an SSID returned from the database query, an AP will determine whether it should broadcast one or more network SSIDs to station 17, as represented by determining step 127 in FIG. 2. If it is determined that there are no available network SSIDs to broadcast to STA 17, method 111 proceeds to response step 123 and the dynamic SSID is broadcast to STA 17 for connection.

However, if determining step 127 identifies that authorized network SSIDs are linked with STA 17 in database 25, each access point 19 within range may locally store the SSID details from either the output of the rules engine, if utilized, or otherwise from the record information retrieved from database 25. As a result, each access point 19 effectively maintains a local network connection table (e.g., in a memory array or local database). This local storage of the network parameters may be used to maintain a post discovery connection and is responsible for setting up the parameters for the SSID, such as the authentication method and/or encryption method.

Upon completion of recording step 129 (or if each access point 19 uses an alternative method to prepare the network SSID for connection), each access point 19 within range will issue a probe response, as part of a response step 131. In the probe response, the requesting STA 17 is notified of the capabilities of the one or more authorized network SSIDs returned from the database query.

Moving forward, the requesting STA 17 can utilize the network information to connect to the access point 19 seamlessly. Furthermore, since only STAs 17 that are properly entered into database 25 will see the broadcasting of the SSID, the network connection can be uniquely encrypted and secured.

As a feature of the present invention, the aforementioned process enables an authorized client device 17 to remain in connection with a private network across various access points 19 as the user 15 roams throughout an expansive network environment. At the same time, the process discreetly broadcasts the private network SSID to only those devices 17 that are listed in a database 25 as being authorized to view the SSID. As a result, broad and reliable network connectivity can be maintained while, at the same time, network visibility is restricted from unauthorized, and potentially harmful, client devices 17, thereby rendering the network more secure.

The invention described in detail above is intended to be merely exemplary and those skilled in the art shall be able to make numerous variations and modifications to it without departing from the spirit of the present invention. All such variations and modifications are intended to be within the scope of the present invention as defined in the appended claims.

What is claimed is:

1. A wireless network connection system comprising:
(a) a wireless network configured with a plurality of subnetworks, each subnetwork having a unique service set identifier (SSID), the wireless network comprising,
(i) one or more network resources,
(ii) a plurality of access points in communication with the one or more network resources,
and
(iii) a database in communication with each of the plurality of access points, the database
maintaining a lookup table; and
(b) an electronic device seeking connection with the wireless network, the electronic device having
an identifier;
(c) wherein the lookup table cross-references the identifier for the electronic device with the SSID of
a selection of the plurality of networks;
(d) wherein the plurality of access points only broadcasts to the electronic device the SSIDs of
subnetworks associated with the identifier for the electronic device in the lookup table.

2. The system as claimed in claim 1 wherein the wireless network is configured to automatically retrieve the identifier from the electronic device.

3. The system as claimed in claim 2 wherein the identifier is unique to the electronic device.

4. The system as claimed in claim 3 wherein the identifier is in the form of a unique Media Access Control (MAC) address.

5. The system as claimed in claim 3 wherein the electronic device establishes connection with the SSID of a first subnetwork broadcast to the electronic device.

6. The system as claimed in claim 5 wherein the electronic device maintains connection to the first subnetwork as the electronic device travels in physical proximity among the plurality of access points.

7. The system as claimed in claim 6 wherein the plurality of access points passes connection of the electronic device to the first subnetwork based on the physical proximity of the electronic device in relation to each of the plurality of access points.

8. The system as claimed in claim 3 wherein the wireless device transmits a probe request to the plurality of access points when attempting to gain access to the wireless network.

9. The system as claimed in claim 8 wherein the wireless network in ingests and parses the probe request in order to retrieve the identifier from the electronic device.

10. The system as claimed in claim 9 wherein the wireless network queries the database to retrieve the SSIDs of subnetworks associated with the identifier for the electronic device in the lookup table.

11. The system as claimed in claim 10 wherein the SSIDs of subnetworks associated with the electronic device is retrieved from the lookup table using one of a direct database lookup, an Application Programming Interface (API) request, and a Remote Authentication Dial-In User Service (RADIUS) access request.

12. The system as claimed in claim 10 wherein the wireless network creates a dynamic SSID for the electronic device if no SSIDs are associated with the identifier for the electronic device in the lookup table.

13. The system as claimed in claim 12 wherein the wireless network records the dynamic SSID associated with the electronic device in the lookup table.

14. The system as claimed in claim 13 wherein the wireless network is configured with a rules engine for establishing a set of connection parameters for the dynamic SSID.

15. The system as claimed in claim 10 wherein the wireless network prohibits connection of the electronic device to the wireless network if no SSIDs are associated with the identifier for the electronic device in the lookup table.
